(19) United States
(12) Patent Application Publication
(10) Pub. No.: US 2007/0190929 A1
(43) Pub. Date: Aug. 16, 2007

(54) Portable terminal

(75) Inventors: Jun Sato, Kawasaki-shi (JP); Hiroshi Kaneko, Akishima-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/393,459

(22) Filed: Mar. 30, 2006

(30) Foreign Application Priority Data
Feb. 14, 2006 (JP) 2006-036911

(51) Int. Cl. H04H 7/00; H04B 1/38

(52) U.S. Cl. 455/3.06; 455/566

(57) ABSTRACT

A portable terminal having a display unit and a slot on which an external memory is mounted detachably, includes an internal memory configured to store contents, a play list including information indicating the contents and information indicating contents stored in the external memory, and location information indicating whether or not the contents are contents stored in the external memory, and a controller which confirms whether or not the contents corresponding to information indicating the contents registered together with the location information exist in the external memory mounted on the slot, when representing the play list on the display unit, in the case where the location information stored in the internal memory indicates the external memory, and when no existence is detected, displaying information indicating the contents in a mode of indicating that the contents cannot be used.

### CROSS-REFERENCE TO RELATED APPLICATIONS

This application is based upon and claims the benefit of priority from prior Japanese Patent Application No. 2006-036911, filed Feb. 14, 2006, the entire contents of which are incorporated herein by reference.

### BACKGROUND OF THE INVENTION

1. Field of the Invention

The present invention relates to a portable terminal capable of handling, for example, a play list of distributed music contents.

2. Description of the Related Art

There is a portable terminal such as a mobile phone or the like which has a capability to register a play list of music distribution contents. The play list is means for storing, for example, a list of a favorite musical piece by a user with respect to the music contents stored in an internal memory or an external memory of the portable terminal. That is, it is possible to configure the play list while selecting user's favorite music pieces among the stored music content group, and it is possible to configure the play list in the user's favorite music reproducing order. Further, the user can reproduce the contents while selecting one or more contents of the list from the contents registered in the play list, or can reproduce the contents registered in the play list successively in its registration order while selecting the play list itself.

Furthermore, it is possible to make a music selection collecting the user's favorite music pieces open to the public, or updates and share it among friends, while uploading the play list produced by the user to a server or the like. In addition, the play list can also be utilized for commercial services, not only the user produces the play list by himself or herself. The commercial services are the case in which, for example, the play list in which famous artist's favorite musical pieces are collected is made to sell as part of the contents, and the like. Here, there will be described the former play list produced by the user.

The portable terminal having such a function is capable of registering the contents in a memory (hereinafter referred to as “internal memory”) contained in the portable terminal. In addition, the portable terminal in recent years is capable of mounting a detachable or removable external memory having a nonvolatile memory such as a flash memory, and usually has a slot of being inserted/removed for one kind or more external memory.

In this case, the contents stored in the internal memory of the portable terminal and the contents stored in the external memory are registered in different play lists respectively. This is because the contents stored in the internal memory can always be reproduced, while the contents stored in the external memory become possible to be reproduced only when the external memory is mounted on the portable terminal. Therefore, the play list managing the contents stored in the internal memory is stored in the internal memory, and the play list managing the contents stored in the external memory is stored in the external memory.

However, in the portable terminal, there is a requirement to register the contents stored in the internal memory and the contents stored in the external memory in the play list stored in the internal memory within the portable terminal in summarized fashion. For example, the Jpn. Pat. Appln. KOKAI Publication No. 2004-145388 discloses a portable playback device having a function to produce and manage the play list of the contents stored in the external memory. However, the external memory is capable of being inserted/removed, thus it is not possible to reproduce the contents when the contents registered in the play list are stored in the external memory which is not mounted on the portable terminal. Therefore, it is necessary for the portable terminal to represent for the user whether or not the contents registered on the play list are capable of being reproduced.

### BRIEF SUMMARY OF THE INVENTION

It is an object of the present invention to provide a portable terminal in which usability is improved on the occasion of managing the play list of the contents.

One aspect of the present invention is characterized by a portable terminal having a slot on which a display unit and an external memory are mounted detachably, comprising: an internal memory configured to store contents, a play list including information indicating the contents and information indicating contents stored in the external memory, and location information indicating whether or not the contents are contents stored in the external memory; and a controller which confirms whether or not the contents corresponding to information indicating the contents registered together with the location information exist in the external memory mounted on the slot, when representing the play list on the display unit, in the case where the location information stored in the internal memory indicates the external memory, and when no existence is detected, displaying information indicating the contents in a mode of indicating that the contents cannot be used. The present invention is established not only as the apparatus invention, but also as the method invention capable of realizing functions described above.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and configure a part of the specification, illustrate embodiments of the invention, and together with the general description given above and the detailed description of the embodiments given below, serve to explain the principles of the invention.

FIG. 1 is a block diagram showing a schematic configuration of a potable terminal according to a first embodiment of the present invention;

FIG. 2 is a view for explaining a method of managing a play list of contents according to the first embodiment of the present invention;

FIG. 3 is a view showing a display example of a display device of an output unit 35 in the case where an external memory 55 is mounted on a slot 50 of a portable terminal 1;

FIG. 4 is a view showing a display example of the display device of the output unit 35 in the case where the external memory 55 is not mounted on the slot 50 of the portable terminal 1;

FIG. 5 is a view for explaining a second embodiment of the present invention; and

FIG. 6 is a view showing a registration example of the case in which URL is registered on the play list.

### DETAILED DESCRIPTION OF THE INVENTION

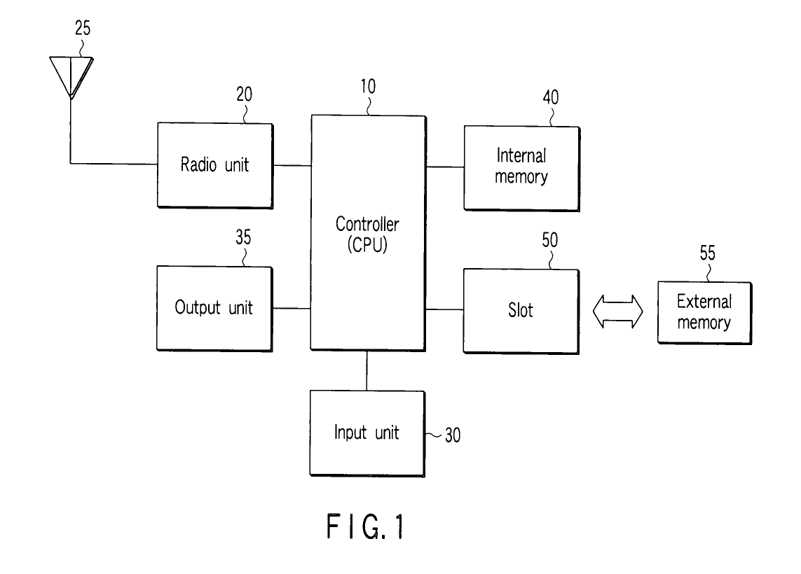

An embodiment of the present invention will be described with reference to the drawings. FIG. 1 is a block diagram showing a schematic configuration of a potable terminal according to a first embodiment of the present invention.

As shown in FIG. 1, the portable terminal according to the first embodiment of the present invention comprises a controller (CPU) 10, a radio unit 20, an antenna 25, an input unit 30, an output unit 35, an internal memory 40, and a slot 50. The portable terminal is, for instance, a mobile phone, PDA or the like. When the portable terminal is the mobile phone, of course, the portable terminal has a telephone call function and other functions equipped with a usual mobile phone, a battery and the like. However, since these functions have no relation directly to the characteristics of the present invention, illustration and explanation thereof are omitted.

In the above-described configuration, the controller 10 carries out control of the entire device or various processing.

The radio unit 20 is an interface for communicating to a base station or the like, not illustrated, via the antenna 25.

The input unit 30 is a device for inputting characters or voice to the portable terminal by the user, and the input unit 30 is an input device such as a keypad, a mike, or a camera or the like.

The output unit 35 is a device for displaying information or outputting voice, and the output unit 35 is a device such as a liquid crystal display (LCD) device or a speaker or the like.

The internal memory 40 is a nonvolatile memory such as EEPROM or the like for storing the contents downloaded or the play list or other information, or a hard disk device or the like housed in the portable terminal.

The slot 50 is a slot for mounting the external memory 55, and the external memory 55 is mounted on this slot 50 detachably. In addition, the slot 50 is not limited to the slot for the external memory, but may be a hard disk drive capable of being connected by USB connection or the like, or another medium of a recording device.

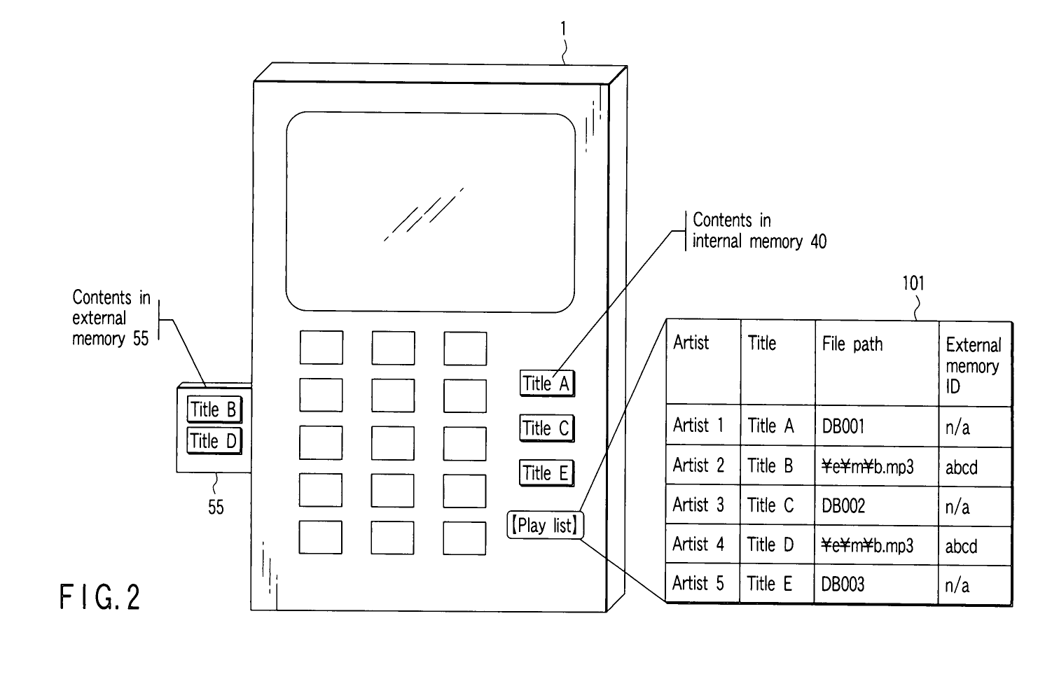

There will be explained about management of the play list of the contents of the portable terminal according to the first embodiment of the present invention configured as described above. FIG. 2 is a view for explaining a method of managing the play list of the contents according to the first embodiment of the present invention.

In FIG. 2, it is assumed that, in the internal memory 40 of the portable terminal 1, music contents whose titles are title A, title C and title E are stored. In addition, music contents whose titles are title B, and title D are stored in the external memory 55. Additionally, the contents in the present embodiment are music contents; however, any contents are permitted as other contents which are the electronic contents such as a movie clip, a still image, an electronic book, an electronic melody or the like. In the first embodiment, in the play list 101, it is possible to register the contents stored in the internal memory 40 and those stored in the external memory 55 in a mixture. In order to distinguish the contents stored in the internal memory 40 from the contents stored in the external memory 55, an “external memory ID” is registered in addition to “artist”, “title” and “file path” which are stored in the usual play list. That is, the “external memory ID” is registered at the same time when contents are registered. Additionally, meta data being the information associated with the contents represented by “artist” and “title” is not limited thereto, there may be another element such as “album name” or the like.

Here, a file path of the contents stored in the internal memory 40 is indicated with “DB***” (*** is an integer), and the external memory ID is indicated with “n/a”. Here, title A, title C and title E are stored in the internal memory 40. There is indicated that these titles are registered in a database (not shown) constructed in the internal memory, and these are registered at database internal number 001, 002 and 003, respectively. Further, there is indicated that with respect to the contents stored in the external memory 55, in this case, the contents of the title B are stored in the file path of “¥e¥m¥b.mp3” of the external memory 55 in which the external memory ID is “abcd” Further, the contents of the title D are stored in the file path of “¥e¥m¥d.mp3”. Additionally, in the case where the contents are stored in the internal memory, when the portable terminal does not adopt a database system but a directory management system, there may adopt the same system of cognate format as that of the file path of the external memory.

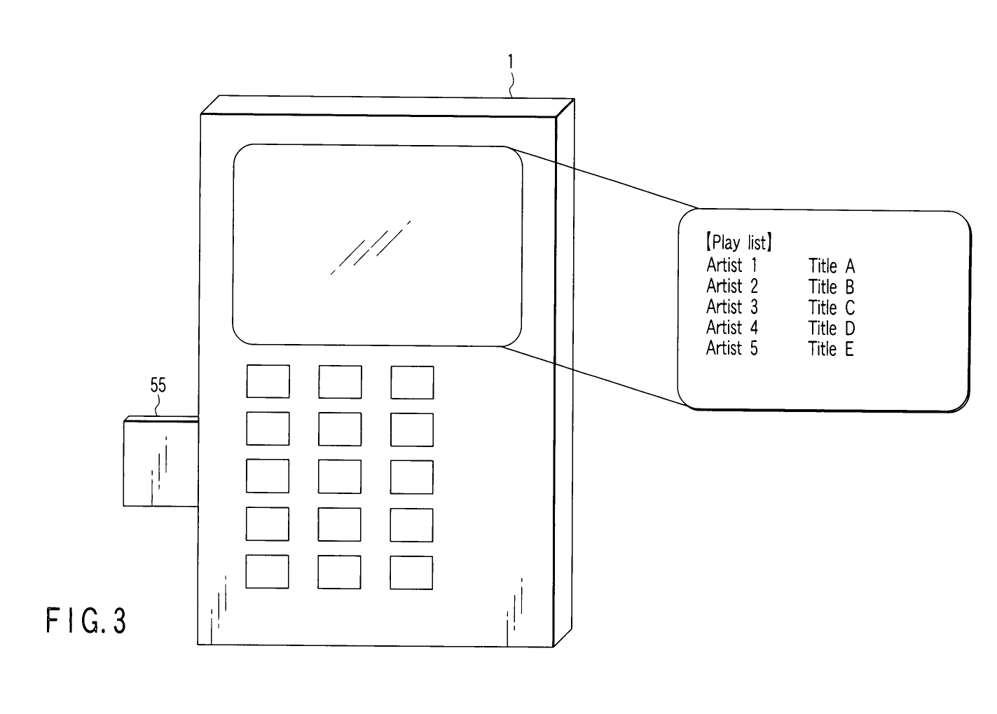

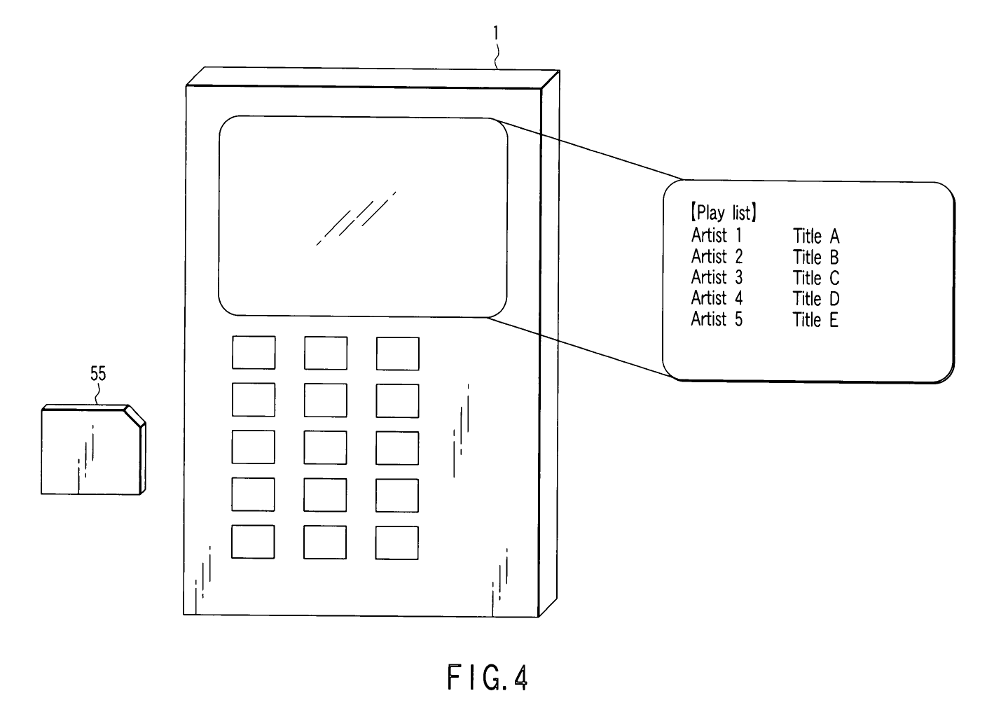

In the above-described configuration, there will be described operation of the portable terminal 1 with reference to FIGS. 3 and 4. FIG. 3 is a view showing a display example of a display device of an output unit 35 in the case where the external memory 55 is mounted on the slot 50 of the portable terminal 1. FIG. 4 is a view showing the display example of the display device of the output unit 35 in the case where the external memory 55 is not mounted on the slot 50 of the portable terminal 1. Here, in the following description, there will be described only the display device as the output unit 35, therefore, there will be described the operation with the output unit 35 as the display device 35. In addition, since control concerning the operation of the portable terminal 1 is entirely carried out at the controller 10; that the controller 10 executes the control is not specified particularly.

As shown in FIG. 3, in the case where the external memory 55 is mounted on the slot 50, the external memory ID is acquired with the portable terminal 1 from the external memory 55. This external memory ID is one kind of serial number which the manufacturer of the external memory adds serially to the external memory, and it is written in the read only area at the time of manufacturing. In this case, it is assumed that “abcd” is acquired as the external memory ID. Subsequently, since the contents of the artists 2 and 4 according to the title B and the title D are capable of being reproduced, as a normal presentation, they become possible to be reproduced, like the contents stored in the internal memory 40. Thus, it is possible to select these contents when the user selects the contents in the play list, resulting in the state capable of being reproduced. In addition, since these contents result in the state capable of being reproduced when the user reproduces the entire play list, the portable terminal 1 reproduces the contents automatically following the list order.

On the contrary, as shown in FIG. 4, in the case where the external memory 55 is not mounted on the slot 50, it is possible to reproduce the contents registered in the internal memory 40 among the contents registered in the play list 101. However, the contents whose external memory ID is “abcd” cannot be reproduced. Therefore, in this case, with respect to the contents incapable of being reproduced, representation indicating that the contents cannot be reproduced is performed. As this representation, for example, gray-out, flag, or icon is displayed, and it causes the user to recognize that the contents cannot be reproduced.

More specifically, when the user selects the contents within the play list, the contents whose external memory ID is “abcd” remain incapable of being reproduced, such contents can not be selected. In addition, when the user reproduces the entire play list, the contents whose external memory ID is “abcd” are capable of being reproduced, thus the portable terminal 1 reproduces the contents following the list order. However, the portable terminal 1 does not reproduce the contents whose external memory is “abcd”, while skipping it, and reproduces the contents whose external memory ID is not “abcd”.

Due to this, even though the contents stored in the internal memory 40 and the contents stored in the external memory 55 are registered in one play list 101, the user can recognize them by the display on the display device 35. Thus, it is not necessary that the user confirms whether or not the contents displayed on the display device 35 are capable of being reproduced, thereby making it possible to avoid user's confusion that the contents are not reproduced although the contents are registered in the play list. In addition, it is preferable to make the contents not selectable (that is, when selection is performed with a cursor, to cause the cursor to skip at the position of contents), in addition to the fact that the contents which cannot be reproduced is made to gray-out display.

Additionally, there will be described a case in which, in the management method described above, for instance, only the contents of the title B are deleted from the external memory 55 with another device such as the personal computer or the like.

In such a case, the contents of the title B will be displayed on the display device 35 as being possible to be reproduced. However, actually, the contents of the title B cannot be reproduced since the contents of the title B are deleted from the external memory 55 having the external memory ID “abcd”. Consequently, the user eliminates the registration of the contents from the play list 101, when the title B is attempted to be reproduced. Accordingly, it is possible to match registration contents of the play list 101 with contents of the external memory 55. Additionally, in this case, only the external memory ID may be deleted without deleting the contents from the play list 101.

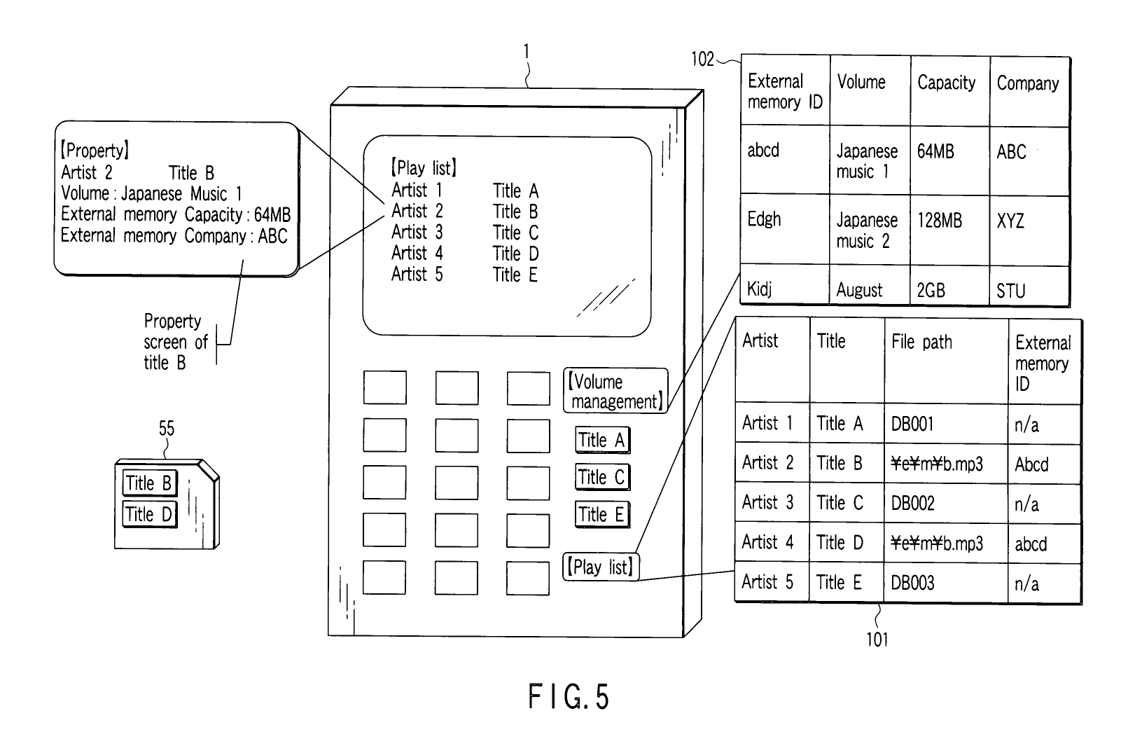

In the first embodiment, judgment of whether or not contents can be reproduced is performed with respect to a certain external memory 55 depending on its mounted condition, and then display such as, for example, gray-out is performed. However, the external memory is not necessarily one, but a plurality of the external memories are prepared, and each of them stores, for example, genre of the contents, artist or the album respectively, thus it is expected that the user possesses and carries a plurality of the external memories. The management method of this case will be described with reference to FIG. 5. FIG. 5 is a view explaining a second embodiment of the present invention. In addition, since equipment constitution of the second embodiment is the same as that of FIG. 1, thus illustration and description are omitted.

In the second embodiment, the user can identify easily in which external memory among the plurality of external memories the contents registered in the play list 101 are stored. As shown in FIG. 5, in the second embodiment, there is prepared an external memory list 102. In the external memory list 102, “external memory ID”, “volume ID (or volume name)”, “capacity” and “maker name” and the like are registered.

Here, there is prepared a confirmation mode for confirming an attribute of the contents in addition to the mode according to reproduction (referred to as “reproduction mode”) as the operation mode. Upon selecting the contents (for instance, the artist and the title are displayed) whose attribute is wanted to be known, the external memory ID of the contents is acquired from the play list 101, and then “volume ID (or volume name)”, “capacity” and “maker name” and the like are acquired from the external memory list 102 with the external memory ID as the key. These are displayed by, for example, pop-up on the display device 35.

In the present embodiment, there have been described “external memory ID”, “volume ID (or volume name)”, “capacity” and “maker name” as the information registered in the external memory list 102. However, although the “external memory ID” capable of identifying to specify at least the external memory is indispensable, information registered in the external memory list is not limited to “volume ID (or volume name)”, “capacity” and “maker name”, but another constitution may be permitted as long as the information is instructive for specifying the external memory.

As a result, even though there are plural external memories, the information helps the user judge which external memory should be mounted in order to reproduce the contents registered in the play list, thus the management of the external memory related to the play list does not become complicated for the user, so that the user can manage the contents easily.

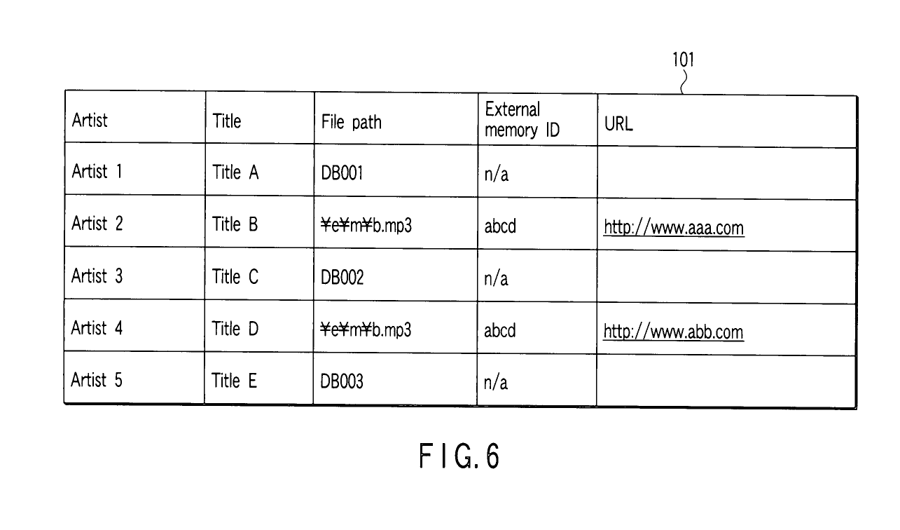

In the above-described respective embodiments, there have been described the embodiments capable of confirming whether or not the contents registered in the play list are possible to be reproduced, or capable of confirming that the contents registered in the play list are stored in which external memory. However the user does not always carry the external memory. In such a case, as shown in FIG. 6, by registering URL from which the contents are acquired to the play list 101, even when the external memory in which the contents are stored is not carried, it is possible to acquire the contents by downloading the contents from the URL. In the case where the contents are stored in the internal memory 40, the URL is not registered since it is not necessary to download the contents, however, the URL may be registered even when the contents are registered in the internal memory 40.

The present invention is not limited to the above-described respective embodiments, and various modifications may be made within the scope not departing from the sprit of the present invention at the enforcement stage.

In the above-described respective embodiments, there is acquired ID of the external memory 55 as the identification information of the external memory 55. However, since the external memory ID is the important value of the copyright protection directly, thus it is necessary for the external memory ID to be concealed so as not to be known by another person. Therefore, the external memory ID is not registered as it is, but it is preferable to register the converted value converted with one-way function (for instance, a hash value calculated with a hash function according to SHA-1 or MD5 or the like).

In the above-described embodiments, the contents and the play list are stored in the internal memory 40; however, in the case of plural internal memories, the contents and the play list may be stored in different memories.

In addition, in the case where the contents are deleted from the external memory 55, when the user attempts to reproduce the contents, the contents are deleted from the play list, or the external memory ID is deleted from among registration contents of the play list concerning the contents. However, it may be also preferable that the contents are deleted from the play list, or the external memory ID is deleted from among registration contents of the play list concerning the contents while collating the contents of the external memory contents registered in the play list and the contents stored in the external memory 55 at the time the external memory 55 is mounted on the slot 50.

According to the present invention, the contents incapable of being reproduced are made not selectable by gray-out display or the like, when the contents are registered in any of the memories of the internal memory and the external memory. By doing this, it is possible to avoid the user's confusion in the case where the contents can not be reproduced although the contents are registered in the play list.

Further, by confirming property which is information associated with the contents made gray-out, it is possible to recognize a volume name of the external memory or characteristic (size or maker) of the external memory, and thus the user can know which external memory should be mounted on the portable terminal in order to reproduce the contents.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A portable terminal having a display unit and a slot on which an external memory is mounted detachably, comprising:
an internal memory configured to store contents, a play list including information indicating the contents and information indicating contents stored in the external memory, and location information indicating whether the contents are stored in the external memory; and
a controller configured to confirm whether the contents corresponding to information indicating the contents registered together with the location information exist in the external memory mounted on the slot, when representing the play list on the display unit, in the case where the location information stored in the internal memory indicates the external memory, and when no existence is detected, displaying information indicating the contents in a mode of indicating that the contents cannot be used.

2. The portable terminal according to claim 1, wherein the location information includes identification information to specify the external memory, the controller compares the identification information of the external memory connected to the slot with the identification information included in the location information, and in case of disagreement, represents information indicating contents in a mode of indicating that the contents corresponding to information indicating the contents registered together with the location information cannot be used.

3. The portable terminal according to claim 1, wherein the play list includes an URL indicating acquisition source of the contents while correlating the URL with information indicating the contents.

4. The portable terminal according to claim 1, wherein the identification information of the external memory stored in the internal memory is registered as a value converted by a one-way function.
